(19) United States
(12) Patent Application Publication
(10) Pub. No.: US 2009/0310495 A1
(43) Pub. Date: Dec. 17, 2009

(54) Session Control System, Session Control Method, and Mobile Terminal

(75) Inventors: Naoya Seta, Tokyo (JP); Haruya Miyajima, Tokyo (JP); Hideki Hayashi, Tokyo (JP); Teruya Fujii, Tokyo (JP)

Correspondence Address: MAIER & MAIER, PLLC, 1000 DUKE STREET, ALEXANDRIA, VA, 22314, US

(73) Assignee: SOFTBANK BB CORP., Tokyo (JP)

(21) Appl. No.: 12/224,797

(22) PCT Filed: Mar. 7, 2007
(86) PCT No.: PCT/JP2007/054471

§ 371 Date: Jul. 14, 2009

(30) Foreign Application Priority Data
Mar. 7, 2006 (JP) 2006-061924

(51) Int. Cl. H04L 12/26

(52) U.S. Cl. 370/252

(57) ABSTRACT

[Problems] Mobile communication enabling continuation of TCP communication while maintaining the quality in a real-time communication.

[Means for Solving Problems] A mobile terminal 3a comprises an application executing section 39 for executing a data transmitting/receiving application, a quality monitoring section 38 for detecting the quality of communication such as of a wireless LAN 4, an address control section 31 for making it enable to provide either or both of a static address and a care-of address to the application as a receiving address for the data transmission/reception depending on the type of the application being executed by the application executing section 39 and the result of the detection t by the quality monitoring section 38, and a network selection switching section 33 for selecting a communication route via a home agent when the fixed address is selected as the receiving address and for selecting a communication route not via the home agent when the care-of address is selected.

### TECHNICAL FIELD

The present invention relates to a session control system for IP mobility and real-time communication, a session control method, and a mobile terminal.

### BACKGROUND ART

In recent years, mobile communications systems have become based on IP (Internet Protocol) technology, and many systems now utilize TCP (Transmission Control Protocol). While the IP address of a terminal is changed when the terminal is moved between access networks in the case of mobile communications, a session is disconnected if the IP address is changed in the case of TCP connection. For this reason, it is common to use IP mobility such as Mobile IP (MIP) to maintain the TCP connection. For example, IETF (Internet Engineering Task Force) promotes standardization of Mobile IPv6 as the specification of the IP mobility (for example, refer to Patent Document 1).

In the case of the IP mobility, as illustrated in FIG. 14, a mobile terminal (MN: Mobile Node) 3a is given a Home Address (HoA: Home of Address) which is a unique IP address which is not changed even if the mobile terminal is moved without depending on the location of this mobile terminal. This HoA is a fixed IP address of a packet core network 2 which is the network (home link) that the mobile terminal 3a basically belongs to. Incidentally, in the case of FIG. 14, the packet core network 2 is connected to other networks, i.e., a wireless LAN 4 and a cellular packet network 6 respectively through a router device 7 and a gateway device 5 to illustrate communication between the mobile terminal 3a and a correspondent terminal (CN: Correspondent Node) 3b which is the other end of the communication line.

A home agent (HA) 21 is installed on the packet core network 2, and serves to store correspondence information (binding information) between the home address of the mobile terminal and the care-of address (CoA: Care of Address) provided in addition to the home address, and manage the home and care-of addresses of the respective mobile terminal MN. Then, when moving to a link other than the home link, the mobile terminal MN acquires the care-of address (CoA) available for the new link after moving, and makes location registration in the home agent 21 with the acquired care-of address (CoA). In the case of the example shown in FIG. 14, the mobile terminal MN moves from the wireless LAN 4 to the cellular packet network 6, and the care-of address is switched from CoA1 to CoA2.

In this case of the IP mobility, as illustrated in FIG. 16, applications 99 run on an ordinary mobile terminal by the use of the home address without using the care-of address which is concealed by the address control section 91. In what follows, the procedure of the packet transmission and reception between the mobile terminal 3a and the correspondent terminal device 3b without using the care-of address will be explained. FIG. 15 is an explanatory view for showing the packet transmission and reception in accordance with a prior art technique.

First, when data D11 is transmitted from the mobile terminal 3a to the correspondent terminal device 3b as illustrated in FIG. 15, the mobile terminal 3a adds a header D12 intended for the home address (HoA) of the correspondent terminal device 3b and an IP header D13 intended for the home agent 21 to the head of the data D11 (encapsulation), and transmits the data D11. The home agent 21 receives the packet D1 intended for this home agent 21, removes the IP header D13 (decapsulation), acquires the home address (HoA) of the correspondent terminal device 3b from the header D12, and transmits the packet to the home address (HoA).

On the other hand, when data D21 is transmitted from the correspondent terminal device 3b to the mobile terminal 3a, the correspondent terminal device 3b transmits a packet D2 to the home address of the mobile terminal 3a. The home agent 21 receives the packet D2 intended for the home address of the mobile terminal 3a, adds an IP header D23 intended for the care-of address (CoA) corresponding to the home address of the mobile terminal 3a (encapsulation), and transmits the packet D2. When receiving the packet D2 intended for the care-of address (CoA), the mobile terminal 3a removes the added IP header D23 (decapsulation) and restores the original packet D21.

However, in the case of the above IP mobility functionality, there is a problem that the maintenance of real-time (RT) communication quality is difficult due to concentration of traffic on the home agent 21 and so forth. More specifically speaking, in the case of the above IP mobility functionality, all the communication links are connected via the home agent 21, i.e., through the so-called MIP virtual interface, and thereby there are several factors to degrade the quality of RT communication on the UDP (User Datagram Protocol) base such as redundant communication routes, communication delays, packet loss due to load concentration.

Because of this, even if MIP is simply used, the quality of TCP communication and the quality of UDP communication cannot be satisfactorily maintained at the same time. From here on, while the bandwidth of the access network becomes broader and the terminal becomes capable of achieving higher performance, the mobile communication is expected to be enabled to maintain a plurality of communication sessions, and thereby an appropriate technique is desired to maintain the quality of TCP communication and the quality of RT communication at the same time.

### [Patent Document 1] Japanese Patent Application No. 2005-340982

### DISCLOSURE OF THE INVENTION

The present invention has been made in order to solve the problems as described above, and it is an object to provide a session control system, a session control method, and a mobile terminal in which it is possible for a mobile communication to separate the interface of IP mobility functionality and the interface of real-time communication functionality implemented in the mobile terminal, dynamically perform session control in accordance with the QoS level of real-time communication, and realize maintenance of the communication quality of the real-time communication while continuing a TCP communication at the same time.

In order to accomplish the object as described above, the present invention provides a session control system for IP mobility and real-time communication, a session control method, and a mobile terminal, for performing communication with mobile terminals operable to perform communication while moving across a communication network; and a home agent operable to relay communication by the use of a static address fixed independent from the location of the mobile terminal and a care-of address variable depending on the location of the mobile terminal, the static address and care-of address being assigned to each of the mobile terminals.

More specifically speaking, the above mobile terminal of the present invention comprises: an application executing section operable to run an application which performs data transmission and reception; a communication quality monitoring section operable to detect the communication quality through the communication network; and an address control section operable to provide the application with either or both of the static address and the care-of address to the application as a receiving address for data transmission and reception in accordance with the type of the application which is run by the application executing section and the detection result by the communication quality monitoring section. The address control section includes the functionality of setting a communication route passing through the home agent when the static address is selected as the receiving address, and selecting a communication route which is not passing through the home agent when the care-of address is selected as the receiving address.

Then, the present invention includes the steps of

(1) running an application which performs data transmission and reception in the mobile terminal and detecting the communication quality through the communication network in this mobile terminal;
(2) providing the application with either or both of the static address and the care-of address to the application as a receiving address for data transmission and reception in accordance with the type of the application which is run on the mobile terminal and the detection result of the communication quality, and
(3) setting a communication route passing through the home agent when the static address is selected as the receiving address and selecting a communication route which is not passing through the home agent when the care-of address is selected as the receiving address, in the step (2).

In accordance with the present embodiment as described above, since the static address (HoA) and the care-of address (CoA) are switchingly used in accordance with the quality of the communication network (QoS level), it is possible to avoid traffic concentration at the home agent during real-time communication by making use of the c/o address if appropriate, while maintaining communication service, which will be disconnected if the address is changed, such as TCP communication at the same time.

In the invention as described above, it is preferred that the mobile terminal notifies a call control device installed on the communication network of the communication quality detected by a communication quality monitoring section, and the call control device instructs a call control section provided in the mobile terminal to optimize the communication route in accordance with the communication quality notified from the mobile terminal, and that the call control section of the mobile terminal selects whether or not to use a communication route through the home agent in accordance with the instruction from the call control device. In this case, while the call control device takes the initiative, it is possible to control the communication on the basis of the communication qualities of both terminals of the communication, and select a more appropriate communication route.

Also, in the invention as described above, it is preferred that the mobile terminal notifies a call control device installed on the communication network of the communication quality detected by a communication quality monitoring section, that the call control device instructs each mobile terminal, which is performing the communication, to optimize the encoding bandwidth in accordance with the communication quality notified from the mobile terminal, and that the mobile terminal performs optimization of the encoding bandwidth in accordance with the instruction from the call control device.

In this case, while the call control device takes the initiative, it is possible to control the encoding bandwidth on the basis of the communication qualities of both terminals of the communication, and adjust the traffic load in stages in accordance with the communication states at both the transmission and reception ends by optimizing the traffic amount in combination with the selection of the communication route as described above.

Furthermore, in the invention as described above, it is preferred that the mobile terminal notifies a call control device installed on the communication network of the communication quality detected by a communication quality monitoring section, that the call control device instructs each mobile terminal, which is performing the communication, to optimize the intervals between outgoing packets in accordance with the communication quality notified from the mobile terminal, and that the mobile terminal performs optimization of the intervals between outgoing packets in accordance with the instruction from the call control device.

In this case, while the call control device takes the initiative, it is possible to control the intervals between outgoing packets on the basis of the communication qualities of both terminals of the communication, and adjust the traffic load in stages in accordance with the communication states at both the transmission and reception ends by optimizing the intervals between outgoing packets in combination with the selection of the communication route as described above.

Alternatively, in the invention as described above, the respective optimization processes can be performed by the mobile terminal taking the initiative. Namely, in the above step (1), the mobile terminal may instruct the call control device and the other correspondent terminal to perform the respective optimization processes (optimization of the communication route, optimization of the encoding bandwidth, optimization of the intervals between outgoing packets) in accordance with the communication quality detected by this mobile terminal, and in the above step (3), each communication terminal device performs the optimization processes according to said instruction in cooperation with the terminal device which is the other end of the communication and the call control device.

In this case, it is possible to perform a variety of optimization processes on the basis of the communication qualities of both terminals of the communication by one of the respective mobile terminals taking the initiative, and adjust traffic load in stages without increasing the burden on the call control device.

### BRIEF DESCRIPTION OF THE DRAWINGS

FIG. 1 is an explanatory view for schematically showing the configuration of a session control system in accordance with an embodiment.

FIG. 2 is a block diagram showing the configuration of the call control device in accordance with the embodiment.

FIG. 3 is a block diagram showing the configuration of the mobile terminal in accordance with the embodiment.

FIG. 4 is an explanatory view for schematically showing the relationship among the respective function blocks of the mobile terminal in accordance with the embodiment.

FIG. 5 is an explanatory view for showing the optimization procedure of the session control system in accordance with an embodiment.

FIG. 6 is an explanatory view for showing the procedure of packet transmission and reception of the session control system in accordance with an embodiment.

FIG. 7 is an explanatory view for schematically showing the operation by the session control system in accordance with an embodiment.

FIG. 8 shows a sequence diagram for showing the procedure of controlling the change of media attribute and optimizing the communication route in accordance with an embodiment.

FIG. 9 is a flow chart for showing the operation of the mobile terminal in accordance with an embodiment.

FIG. 10 is a flow chart for showing the operation of the mobile terminal in accordance with an embodiment.

FIG. 11 is a flow chart for showing the operation in the call control device in accordance with an embodiment.

FIG. 12 is a flow chart continued from FIG. 11 for showing the operation in the call control device in accordance with an embodiment.

FIG. 13 is a flow chart continued from FIG. 11 for showing the operation in the call control device in accordance with an embodiment.

FIG. 14 is an explanatory view for schematically showing the configuration of a session control system in accordance with a prior art technique.

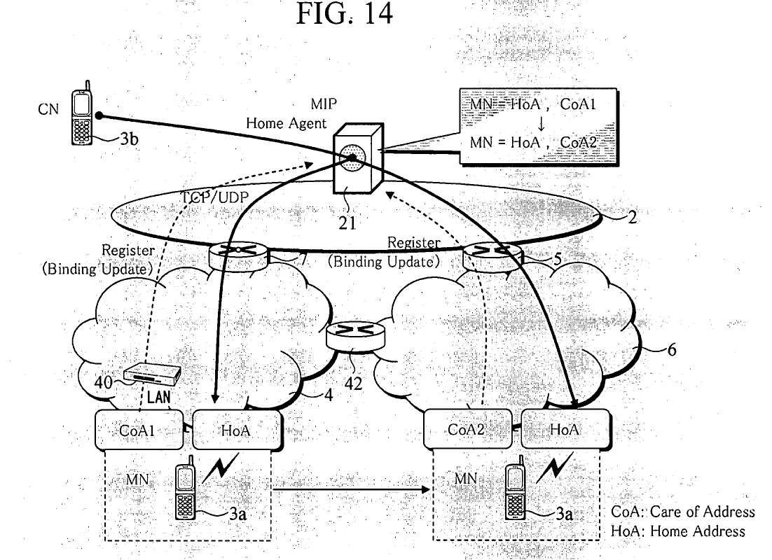

FIG. 15 is an explanatory view for showing the procedure of transmitting and receiving packets in accordance with the prior art technique.

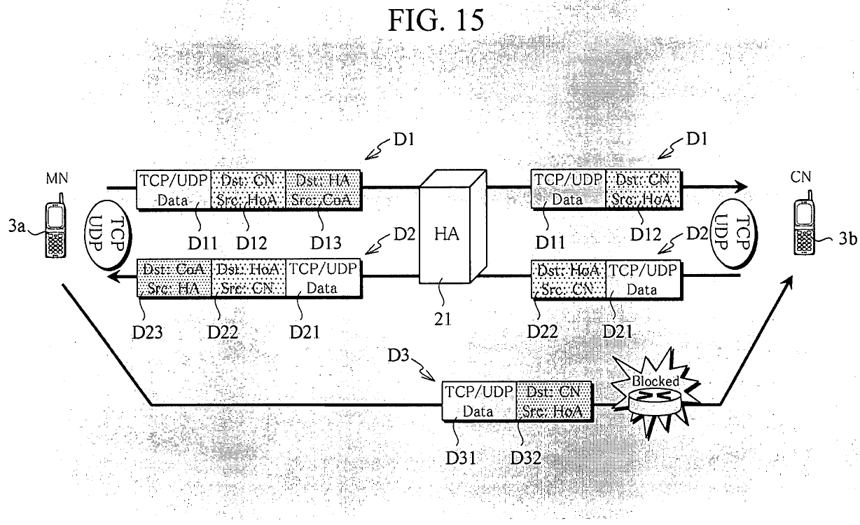

FIG. 16 is an explanatory view for schematically showing the relationship among the respective function blocks of the mobile terminal in accordance with the prior art technique.

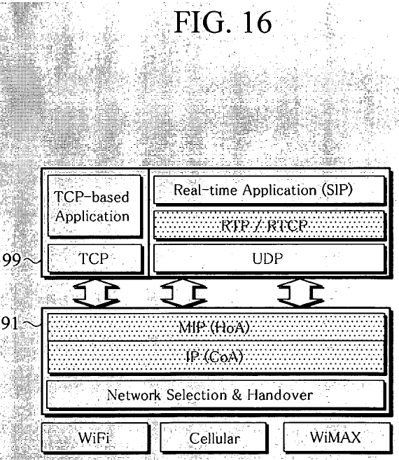

### BEST MODE FOR CARRYING OUT THE INVENTION

### Configuration of Session Control System

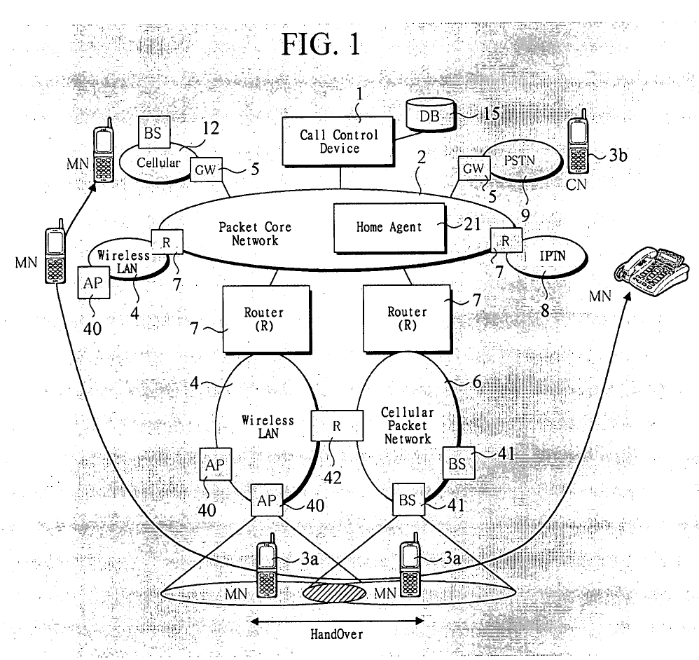

An embodiment of the present invention will be explained with reference to the accompanying drawings. FIG. 1 is an explanatory view for schematically showing the configuration of a session control system in accordance with the present embodiment.

As shown in FIG. 1, the session control system of the present embodiment is provided with a call control device 1 such as a SIP (Session Initiation Protocol) server section, a router device 7 through which a packet core network (IP network) 2 serving as the core of a packet switching system for voice communication by a packet switching system and a cellular packet network 6 for communication with a mobile terminal 3a such as a cellular phone are connected with each other, and a router device 7 through which the packet core network 2 and a Wireless LAN 4 (WLAN: Wireless Local Area Network) for voice communication by a packet switching system.

The packet core network 2 is connected further to other communication networks than the cellular packet network and the wireless LAN 4, i.e., an IP telephone network 8 and a PSTN (Public Switched Telephone Network) 9 for voice communication through the gateway device 5 and router device 7 respectively. Meanwhile, the gateway device 5 of the present embodiment may be implemented with a media gateway control device (MGC), a signaling gateway (SG), a media gateway (MGW) and so forth. Usually, it is preferred that MGC handles SIP and controls the signaling gateway (SG) and the media gateway (MGW) respectively for signaling and line connection.

In addition, the home agent 21 is installed in the packet core network 2. This home agent 21 stores and manages the correspondence information (binding information) between the home address (HoA) and the care-of address (CoA) of the mobile terminal 3a. Then, when moving to a link other than the home link, the mobile terminal acquires the care-of address available for the new link after moving, and makes location registration in the home agent 21 with the acquired care-of address.

### (Configuration of Call Control Device)

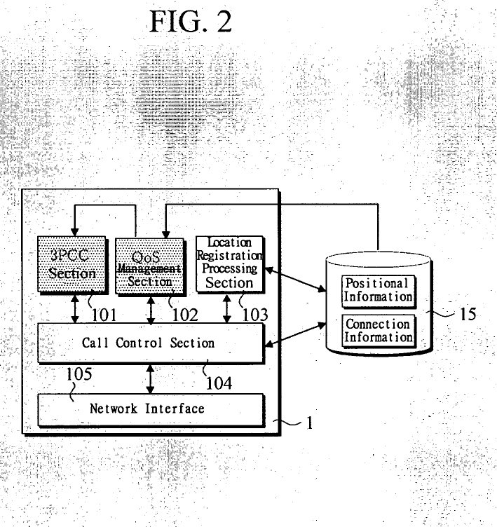

FIG. 2 is a block diagram showing the configuration of the call control device in accordance with the present embodiment. As shown in this figure, the call control device 1 is provided with a location registration processing section 103, a call control section 104, and a network (I/F) 105 for implementing call control functionality.

The call control section 104 is a module for performing call transmission and reception process by exchanging a call control message with the mobile terminal 3a and transmitting this call control message to the correspondent terminal device 3b as a call receiver. The location registration processing section 103 is a module for saving or updating the location registration message when receiving this location registration message from the call control section 104. The location registration processing section 103 saves not only HoA but also CoA of each terminal as the positional information. The network interface 105 is a module including a physical network interface and having the network control functions and basic protocol stacks (TCP/UDP/IP and the like) corresponding to this physical network interface, such as device drivers, dial-up and the like functions.

In addition, the call control device 1 is provided with a QoS management section 102 and 3PCC (3PCC: 3rd Party Call Control) section 101. When receiving QoS control signals (alarm signal, quality reset signal, best quality signal) from the call control section 104, the QoS management section 102 updates the connection state record corresponding thereto in a registration data server 15. When updating this record, the generation time of the received QoS control signal is recorded, and the QoS management section 102 instructs the 3PCC section 101 to change the codec, perform route optimization control process and so forth in accordance with the states of the signals which are received within a predetermined period. Also, the 3PCC section 101 is a module for instructing a group of designated terminal devices to change the codec and the packet transmission interval and perform route optimization control by the use of the procedure of 3PCC in response to the instruction from the QoS management section 102.

Furthermore, the call control device 1 is provided with the registration data server 15 for storing the positional and connection information of the respective users, and the location registration processing section 103 for making location registration of the respective users. This positional information is generally given as data for associating IDs for identifying clients (telephone number, SIP-URI and the like) with CoA and HoA which are listening addresses of which location registration has been made. The connection information is generally given as data containing IDs for identifying calls which have been connected, the pair of client IDs communicating with each other, the codec being used, the priority order of codecs, the current pair of addresses (CoA/HoA) as the incoming call listening addresses, the source of the QoS signal, the reception time of the QoS signal, and so forth.

In the call control device 1 constructed as described above, the call control section 104 registers the connection state information indicative of the connection state of each user in the registration data server 15, and transfers the positional information of each user to the location registration processing section 103. When receiving the positional information from the call control section 104, the location registration processing section 103 compares the transferred positional information with the positional information which has been registered in the registration data server 15, and updates the positional and connection state information of the mobile terminal 3a if it is determined that the user (mobile terminal 3a) has moved to the communication network (the network currently being accessed).

(Configuration of Mobile Terminal Device)

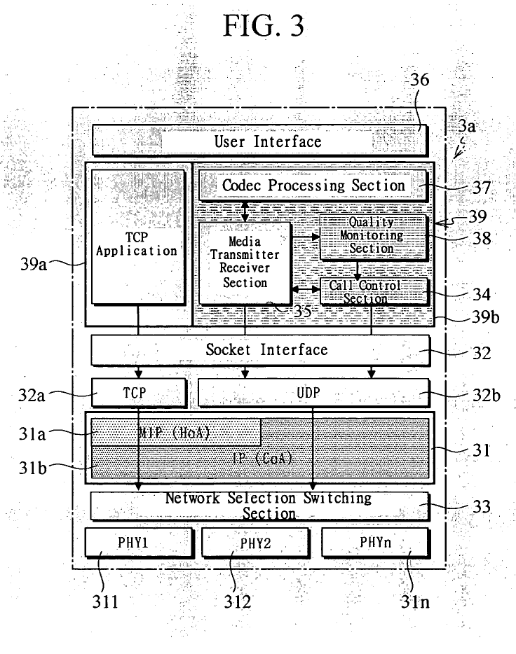

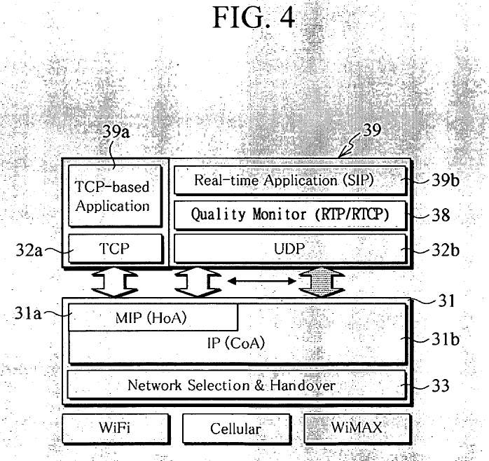

FIG. 3 is a block diagram showing the configuration of the mobile terminal in accordance with the present embodiment, and FIG. 4 is an explanatory view for schematically showing the relationship among the respective function blocks shown in FIG. 3. As shown in FIG. 3, the mobile terminal 3a (and the correspondent terminal device 3b) is provided with an application executing section 39, a user interface 36, a network selection switching section 33, and network interfaces 311 to 31n.

The application executing section 39 is an arithmetic processing section capable of running a variety of application software, and includes a TCP executing section 39a for running a TCP application and an RT executing section 39b for running a real-time application. The application software which can be run by the TCP executing section 39a may be, for example, a Web browser, file transfer software, mailer software, or other communication application software on the basis of TCP. The communication by the application executing section 39 is performed by connecting with a TCP interface 32a through a socket interface 32, and connecting with the communication network 311 to 31n from the TCP interface 32a through a MIP section 31a and the network selection switching section 33 of the address control section 31.

On the other hand, the application software which can be run by the RT executing section 39b may be, for example, a voice conversation application on the basis of SIP or other communication application software on the basis of UDP. The communication by the RT executing section 39b is performed by connecting with a UDP interface 32b through the socket interface 32, connecting selectively with the MIP section 31a or IP section 31b of the address control section 31 from the UDP interface 32b, and connecting with the communication network 311 to 31n through the network selection switching section 33.

Specifically speaking, the RT executing section 39b includes a codec processing section 37, a media transmitter receiver section 35, a quality monitoring section 38, a call control section 34 and an address control section 31. The media transmitter receiver section 35 is a module for transmitting and receiving real-time data such as voice, motion image or the like to/from the terminal device 3b which is the other end of the communication line. The quality monitoring section 38 serves to monitor QoS of real-time communication. The quality monitoring section 38 is a module for comparing QoS with a threshold value, determining if QoS is degraded, and transmits an alarm to the call control device if degraded. In this case, examples of QoS include the average jitter of communication packets, the packet loss ratio, and the average round-trip latency.

The call control section 34 is a module for transmitting and receiving call control messages to/from the call control device 1 or the terminal device 3b which is the other end of the communication line, and performing media negotiation such as the registration process, the process of directing/receiving a call, a sound codec process and so forth. In the case of the present embodiment, the call control section 34 dynamically changes the codec and the receiving address in accordsance with the instruction from the call control device 1.

Also, as illustrated in FIG. 4, the address control section 31 is a module for selectively providing either or both of HoA and CoA to the application as the receiving address for data transmission and reception in accordance with the type of the application which is run by the application executing section 39 and the detection result by the quality monitoring section 38, and includes the MIP section 31a for performing communication by the use of HoA and the IP section 31b for performing communication by the use of CoA. The MIP section 31a is a module for making location registration in the home agent 21, and performing a usual MIP process such as IP/UDP capsulation. Generally speaking, when this MIP process is performed, the application can use only the MIP interface. However, in the case of the present embodiment, the MIP section 31a and the IP section 31b are separately implemented, and thereby the UDP interface 32b can selectively use the MIP communication or non-MIP communication in accordance with the status of the application.

Furthermore, the address control section 31 is provided with the functionality of providing a communication route which is not passing through the home agent 21, in the case where the mobile terminal 3a makes use of HoA as the receiving address, and it is determined that CoA is used for the current communication route when the current communication route through the home agent 21 is investigated.

The network selection switching section 33 is a module for monitoring the plurality of network interfaces 311 to 31n, and selecting and connecting the optimal interface in accordance with the preference of the user, the cost, the communication quality (the electromagnetic strength of radio waves) or the like. In addition to this, the network selection switching section 33 is provided with the functionality of activating a plurality of interfaces at the same time for handover, and instructing the MIP section 31a and the call control section 34 to make location registration.

The network interface 311 to 31n is provided with a physical network interface, the network control sections (NCU) and basic protocol stacks (TCP/UDP/IP and the like) corresponding to this physical network interface, such as device drivers, dial-up and the like functions.

The user interface 36 is a module including a sound card connected to a microphone, a speaker and the like, and an input/output device provided with a driver, a software interface, an AD/DA conversion section, and so forth. The codec processing section 37 is a module for performing a conversion process (codec conversion process) of the data transferred from the user interface 36 and the media transmitter receiver section 35 in an optimal format which can be handled by relevant modules or the correspondent node.

(Optimization Processes)

In the case of the present embodiment, the communication quality is monitored by the system as described above in each terminal, and if the quality falls short of a certain level a QoS control signal is transmitted to the call control device 1, which is therefore notified of the communication qualities of the respective terminal devices and performs a variety of optimization processes in combination and in stages in accordance with the signal states notified by the respective terminal devices at predetermined intervals.

(a) Reception of alarm from one terminal
Optimization by changing media attribute
   (b) Reception of alarm from both terminals
Optimization by changing the route

Specifically, first, in the case of (a) optimization process by changing media attribute, it is assumed that the communication quality of the access network to which one terminal belongs is connected is degraded, and the call control device 1 dynamically instruct this terminal to change the intervals between outgoing packets and/or change the current codec to a narrow band codec. On the other hand, in the case of (b) optimization process by changing the route, it is assumed that the home agent 21 has been overloaded, and the MIP communication with HoA and a non-MIP communication with CoA is switchingly used.

Furthermore, after performing the session control process in accordance with either the optimization (a) or the optimization (b), if the quality alarm is received again in connection with the communication between the pair of the terminals, the quality of RT communication is maintained by controlling the other terminal. On the other hand, the TCP communication continuously utilizing HoA can be maintained at the same time by virtue of the MIP mobility. Incidentally, the two types of session control in accordance with the proposal can be implemented by combining a standard SIP mobility which can be used to dynamically change the media attribute and IP address of the current communication, and SIP-3PCC which can be used by a third party to perform the call control process.

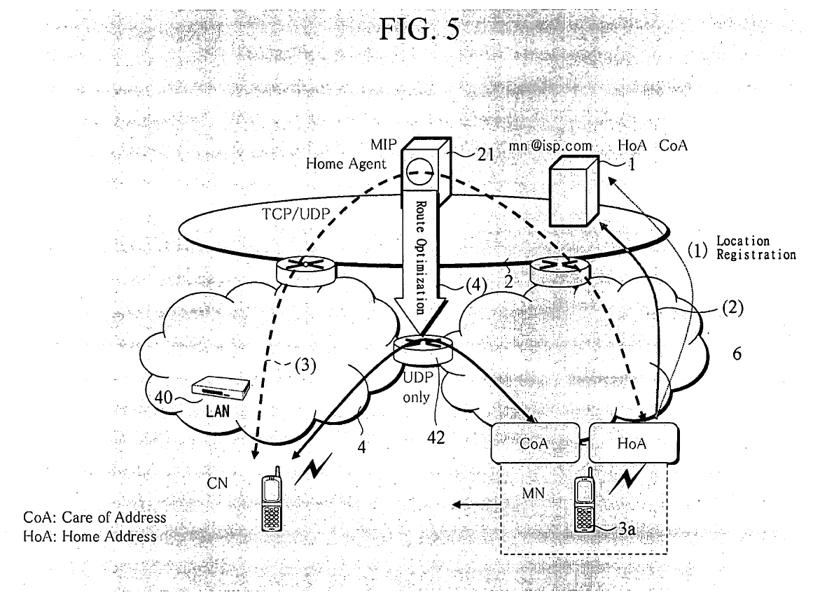

More specifically speaking, the above optimization processes can be performed as follows. Namely, as illustrated in FIG. 5, the communication is controlled as follows.

(1) Both CoA and HoA of the mobile terminal 3a are registered in the call control device 1.
(2) The QoS control signal is transmitted to the call control device 1 from the mobile terminal 3a (or 3b) when QoS of RT communication is degraded at this the mobile terminal.
(3) The call control device 1 performs the communication route optimization process (switching to a non-MIP communication) or the media attribute switching optimization process (changing the codec bandwidth and/or changing the intervals between outgoing packets) in accordance with the state notification from the mobile terminal.
(4) In the case where QoS is in a good level, the call control device 1 performs communication control by increasing the bandwidth of the codec and/or returning to MIP communication.

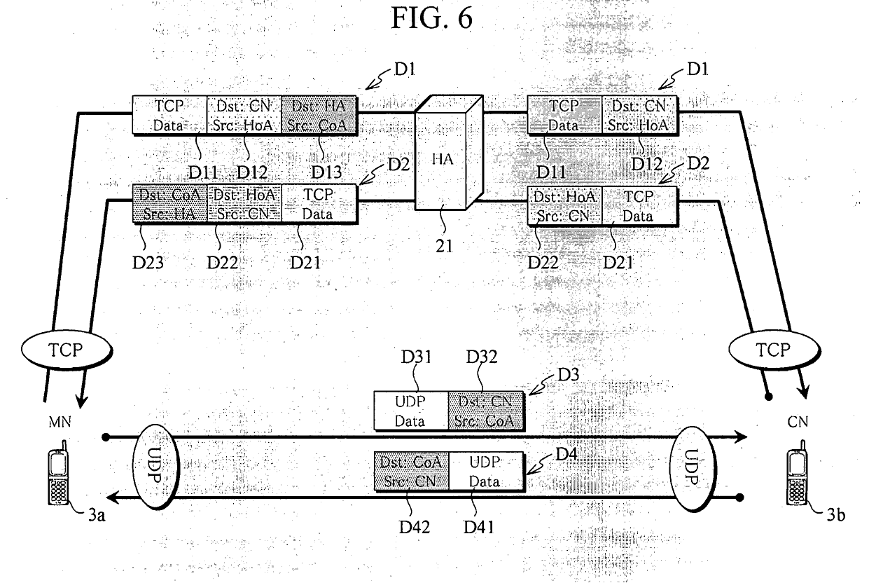

The optimization control of the communication route is performed as follows. When data D11 is transmitted from the mobile terminal 3a to the correspondent terminal device 3b as illustrated in FIG. 6, the mobile terminal 3a adds a header D12 intended for the home address (HoA) of the correspondent terminal device 3b and an IP header D13 intended for the home agent 21 to the head of the data D11 (encapsulation), and transmits the data D11. The home agent 21 receives the packet D1 intended for this home agent 21, removes the IP header D13 (decapsulation), acquires the home address (HoA) of the correspondent terminal device 3b from the header D12, and transmits the packet to the home address (HoA).

On the other hand, when data D21 is transmitted from the correspondent terminal device 3b to the mobile terminal 3a, the correspondent terminal device 3b transmits a packet D2 to the home address of the mobile terminal 3a. The home agent 21 receives the packet D2 intended for the home address of the mobile terminal 3a, adds an IP header D23 intended for the care-of address (CoA) corresponding to the home address of the mobile terminal 3a (encapsulation), and transmits the packet D2. When receiving the packet D2 intended for the care-of address (CoA), the mobile terminal 3a removes the added IP header D23 (decapsulation) and restores the original packet.

On the other hand, in the case of the communication based on UDP, data transmission and reception is performed directly between the mobile terminal 3a and the correspondent terminal device 3b, as shown in packets D3 and D4, by adding headers D32 and D42 of the care-of address at both ends. By this configuration, as illustrated by line (4) of FIG. 5, a communication route which is not passing through the home agent 21 is created (for example, a communication route through a router 42), and thereby it is possible to avoid load concentration at the home agent 21. Hence, the mobile terminals 3a and 3b can perform MIP communication and non-MIP communication at the same time, and the call control device 1 can manage the two receiving addresses (HoA and CoA) of the respective terminal devices.

(Session Control Method)

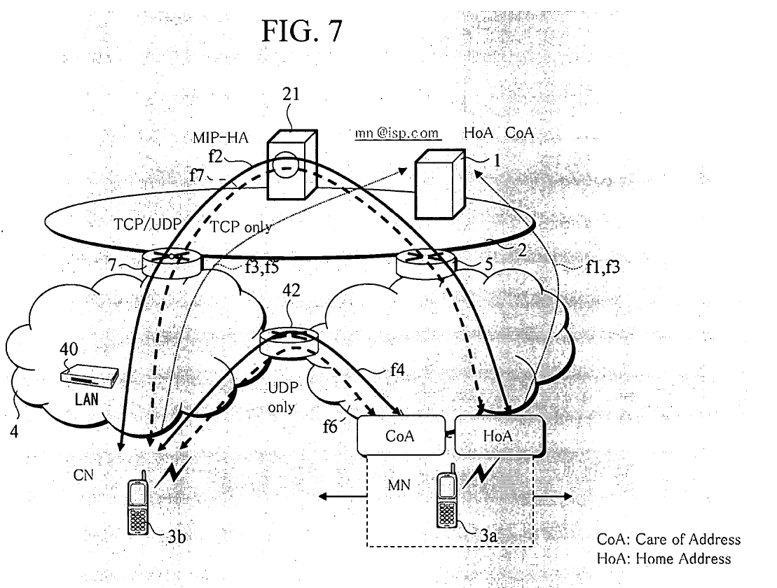

The session control method in accordance with the present invention can be implemented by operating the session control system having the structure as described above. FIG. 7 is an explanatory view for schematically showing the session control by the session control system of the present embodiment.

(f1) In FIG. 7, the mobile terminal 3a makes location registration of both HoA and CoA in the call control device 1. (f2) Next, when starting the communication, the TCP executing section 39a and the RT executing section 39b of the mobile terminal 3a perform MIP communication by the use of HoA.

(f3) Then, when the quality of RT communication falls short of a certain level, the mobile terminal 3a transmits a quality alarm signal to the call control device 1 by making use of the INFO method (related reference: “The SIP INFO Method”, RFC2976, October, 2000). (f4) If receiving alarm signals from both the communicating terminals within a predetermined time, the call control device 1 performs the route optimization control process by making use of 3PCC as illustrated in FIG. 5.

(f5) Thereafter, if a quality alarm signal from the correspondent terminal device 3b is received, (f6) the codec used by the terminal and/or the intervals between outgoing packets are changed. (f7) On the other hand, the session of TCP communication is maintained with HoA by MIP.

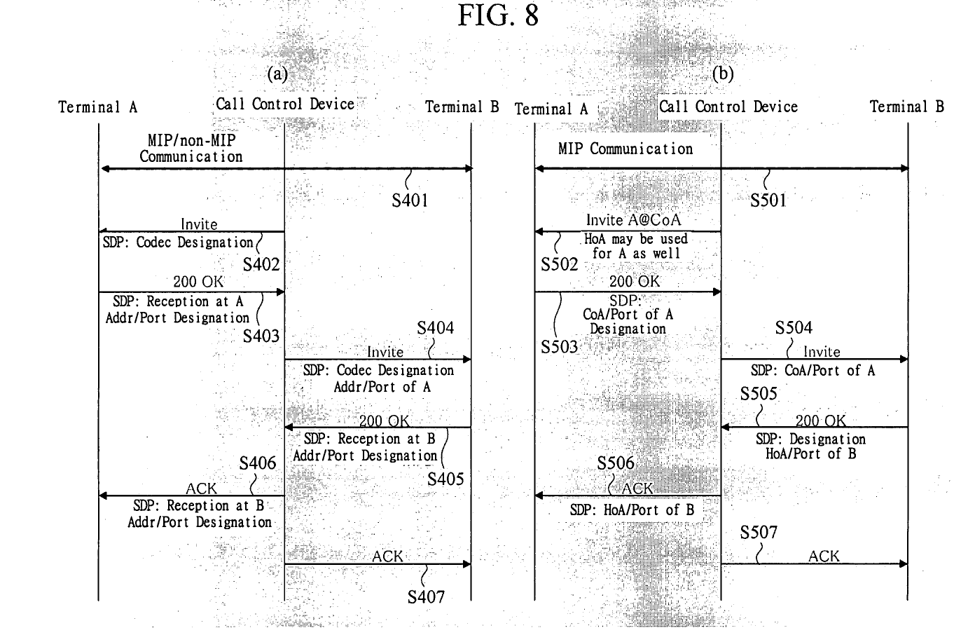

The procedure of changing the media attribute and optimizing the communication route in accordance with present embodiment will be explained. FIG. 8(a) is a sequence diagram for showing the operation when the media attribute is changed, and FIG. 8(b) is a sequence diagram for showing the operation when the communication route is optimized. Incidentally, while FIG. 8(a) illustrates the case where the codec is changed as the media attribute, the intervals between outgoing packets can be changed by the similar operation.

As illustrated in FIG. 8(a), it is assumed that MIP or non-MIP communication is performed between the mobile terminals 3a and 3b in step S401. Then, for example, if the call control device 1 sends a request (Invite) to the mobile terminal 3a by designating a codec (or intervals between outgoing packets) in step S402, the mobile terminal 3a designates a receiving address and a port in step S403 in response to the request. The call control device 1 then sends a request (Invite) to the correspondent terminal device 3b by designating the codec (or intervals between outgoing packets) in step S404 and notifies the correspondent terminal device 3b of the receiving address and the port which are designated by the mobile terminal 3a. The correspondent terminal device 3b designates own receiving address and port in step S405.

The call control device 1 notifies the mobile terminal 3a of the receiving address and the port which are designated by the correspondent terminal device 3b as ACK in step S406, and sends ACK to the correspondent terminal device 3b when communication with the mobile terminal 3a is established in step S407.

Also, when communication with HoA (MIP communication) is performed between the mobile terminals 3a and 3b as illustrated in FIG. 8(b), this MIP communication can be switched to communication with CoA (non-MIP communication) as follows. For example, if the call control device 1 sends a request (Invite) of non-MIP communication to the mobile terminal 3a in step S502, the mobile terminal 3a designates the care-of address and a port in step S503 in response to the request. The call control device 1 then sends a request (Invite) of non-MIP communication to the correspondent terminal device 3b in step S504 and notifies the correspondent terminal device 3b of the care-of address and port which are designated by the mobile terminal 3a. The correspondent terminal device 3b designates own home address and port in step S505. Incidentally, if route optimization is performed also for the correspondent terminal device 3b, the correspondent terminal device 3b can designate a care-of address (CoA) and a port in step S505.

The call control device 1 notifies the mobile terminal 3a of the home address and a port of the correspondent terminal device 3b as ACK in step S506, and sends ACK to the correspondent terminal device 3b when communication is established in step S507.

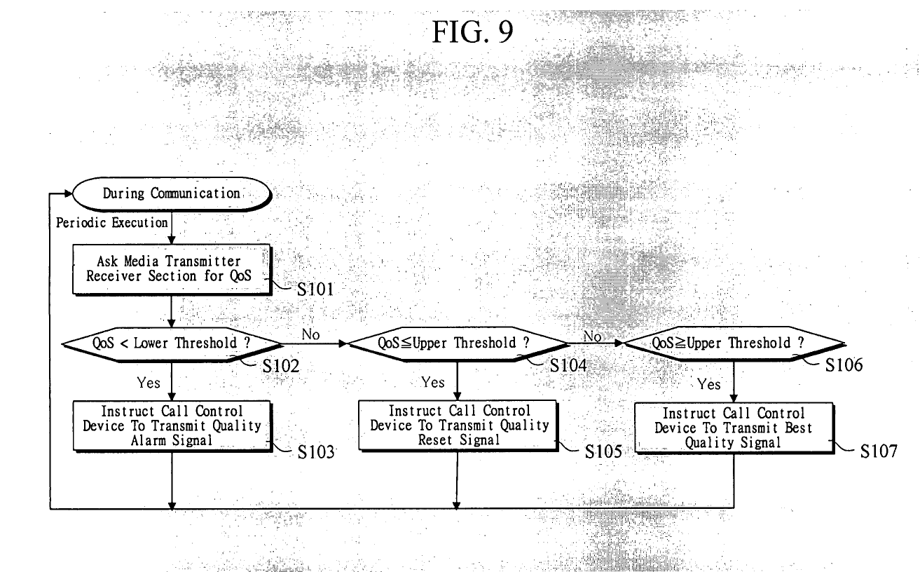

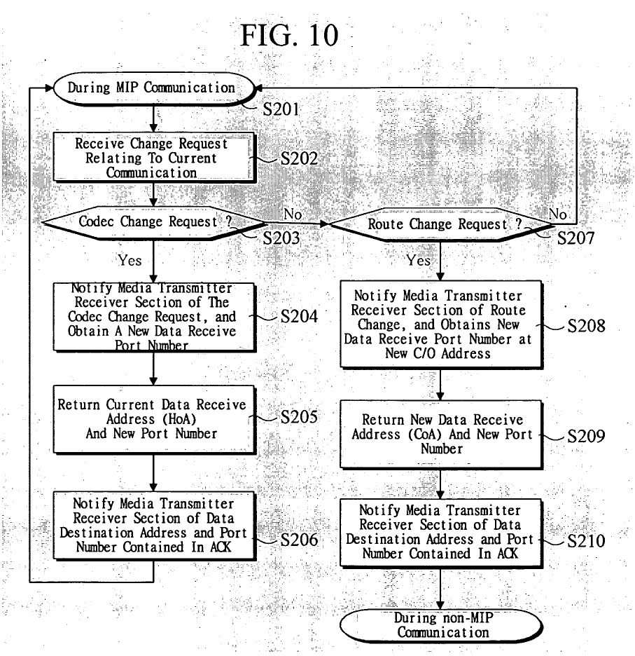

Next, with respect to the session control method as described above, more specific operations of the mobile terminal and the call control device will be explained. FIG. 9 and FIG. 10 are flow charts for showing the operation of the mobile terminal 3a.

First, the communication quality is monitored in the mobile terminal side. Specifically, as illustrated in FIG. 9, the mobile terminal 3a periodically interrogates the media transmitter receiver section 35 to obtain QoS information in step S101, and monitors if QoS falls under a lower threshold level in step S102. If QoS falls under a lower threshold level in step S102 (i.e., the “Yes” branch from step S102), the call control device 1 is instructed to transmit the quality alarm signal in step S103.

On the other hand, if it is determined that QoS is no lower than the lower threshold level in step S102 (i.e., the “No” branch from step S102), the mobile terminal 3a monitors if QoS is no higher than a upper threshold level in step S104. If QoS is no higher than the upper threshold level (i.e., the “Yes” branch from step S104), the call control device 1 is instructed to transmit the quality reset signal in step S105. Conversely, if it is determined that QoS is higher than the upper threshold level in step S104 (i.e., the “No” branch from step S104 followed by step S106), the call control device 1 is instructed to transmit the best quality signal in step S107.

The call control device 1 takes the initiative in performing the respective optimization processes in accordance with the QoS control signal transmitted to the call control device 1 from the mobile terminal in this manner. At this time, in the mobile terminal side, when a change request is received during MIP communication in steps S201 and S202 of FIG. 10, it is determined whether or not the change request is a codec change request in step S203. If the change request is a codec change request (i.e., the “Yes” branch from step S203), the mobile terminal notifies the media transmitter receiver section 35 of the codec change request, obtains a new port number for data reception in step S204, and returns the current data receiving address (HoA) and the new port number in step S205. Thereafter, a destination address and a port number which are contained in ACK are notified to the media transmitter receiver section 35 in step S206.

If it is determined in step S203 that the change request is not a codec change request (i.e., the “No” branch from step S203), it is determined whether or not the change request is a route change request in step S207. If the change request is not a route change request, the process is returned to step S201 followed by waiting for receiving the next change request.

If the change request is a route change request in step S207, the mobile terminal notifies the media transmitter receiver section 35 of the route change request, obtains a new port number for data reception at a new care-of address (CoA) in step S208, and returns this new data receiving address (CoA) and the new port number in step S209. Thereafter, a destination address and a port number which are contained in ACK are notified to the media transmitter receiver section 35 in step S210.

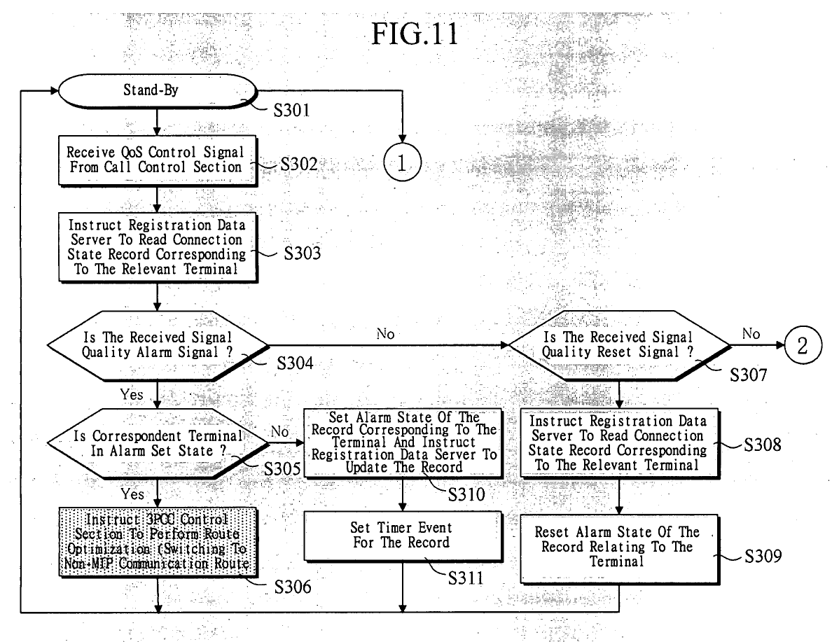

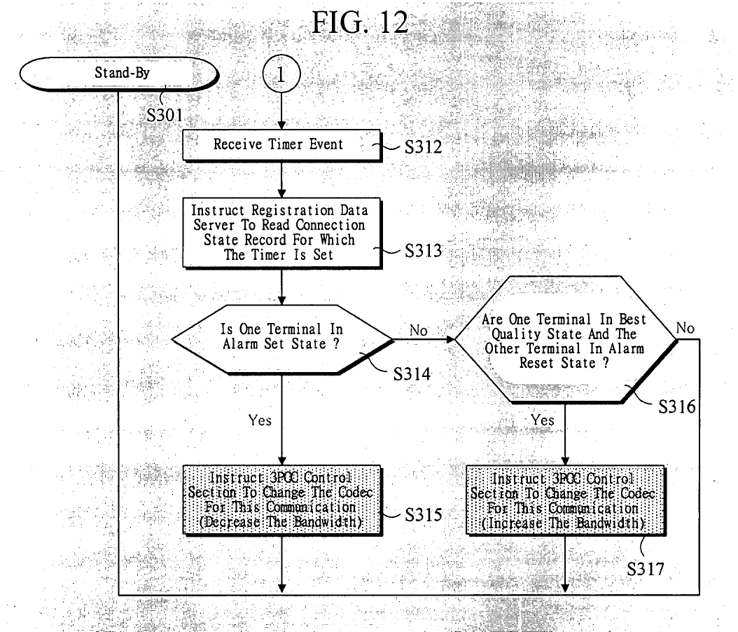

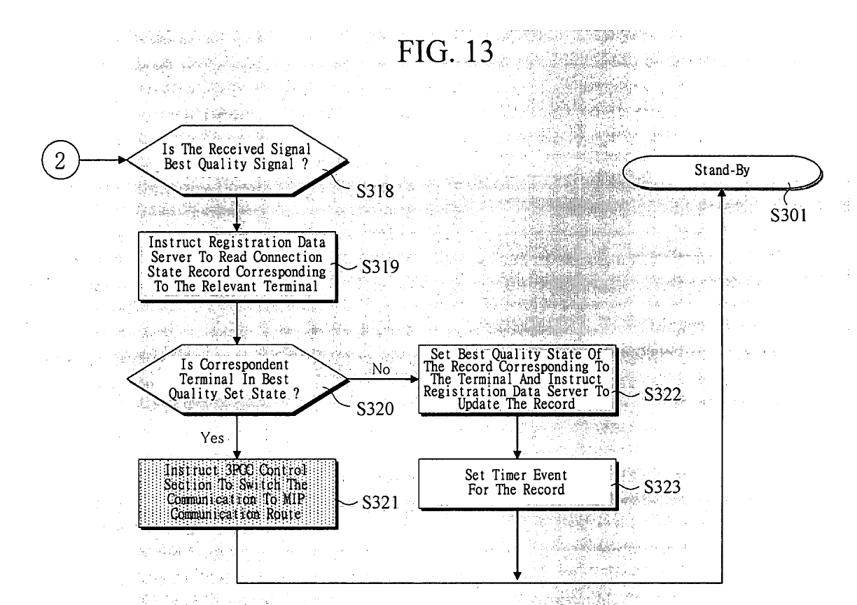

FIG. 11 through FIG. 13 are flow charts for showing the operation in the call control device 1 side. When a QoS control signal is received from the call control section 104 during a stand-by state (S301 and S302), the call control device 1 instructs the registration data server 15 to read a connection state record corresponding to the relevant terminal in step S303, and determines whether or not the received signal is the quality alarm signal in step S304.

If the received signal is the quality alarm signal in step S304 (i.e., the “Yes” branch from step S304), it is determined whether or not the correspondent terminal is in an alarm set state in step S305. If the correspondent terminal is in an alarm set state, the 3PCC section 101 is instructed to perform route optimization by switching the communication route to a non-MIP communication route in step S306. Also, if it is determined in step S305 that the correspondent terminal is not in an alarm set state (i.e., the “No” branch from step S305), the alarm state of the record corresponding to the terminal is set, followed by instructing the registration data server 15 to update the record in step S310, setting a timer event for the record in step S311, and returning to the stand-by state in step S301.

On the other hand, if it is determined in step S304 that the received signal is not the quality alarm signal (i.e., the “No” branch from step S304), it is determined whether or not the received signal is the quality reset signal in step S307. If the received signal is the quality reset signal, the call control device 1 instructs the registration data server 15 to read a connection state record relating to the terminal in step S308, reset the alarm state of the record relating to the terminal in step S309, and returning to the stand-by state in step S301.

On the other hand, if the received signal is not the quality reset signal (i.e., the “No” branch from step S307), it is determined that the received signal is the best quality signal in step S318, followed by instructing the registration data server 15 to read a connection state record relating to the terminal in step S319, and determining whether or not the correspondent terminal is in a best quality set state in step S320. If the correspondent terminal is in a best quality set state (i.e., the “Yes” branch from step S320), the 3PCC section 101 is instructed to change MIP communication in step S321, and the process returns to the stand-by state in step S301. Conversely, if it is determined in step S320 that the correspondent terminal is not in a best quality set state (i.e., the “No” branch from step S320), the best quality set state of the record corresponding to the terminal is set, followed by instructing the registration data server 15 to update the record in step S322, setting a timer event for the record in step S323, and returning to the stand-by state in step S301.

Then, when a timer event in step S312 is received in the stand-by state (step S301), the call control device 1 instructs the registration data server 15 to read a connection state record for which a timer is set in step S313. Thereafter, it is determined whether or not one of the communicating terminals in an alarm set state in step S314. If one terminal is in an alarm set state (i.e., the “Yes” branch from step S304), the 3PCC section 101 is instructed to change the codec for this communication (reduce the bandwidth) in step S315. On the other hand, if it is determined in step S314 that neither terminal is in an alarm set state (i.e., the “No” branch from step S314), it is determined whether or not one terminal is in the best quality state and the other terminal is in the alarm reset state in step S316. In such a case (i.e., the “Yes” branch from step S316), the 3PCC section 101 is instructed to change the codec for this communication (increase the bandwidth) in step S317. Conversely, if it is determined in step S316 that these terminals are not in such states that one is in the best quality state and the other is in the alarm reset state, the process returns to the stand-by state in step S301.

### ACTIONS/EFFECTS

In accordance with the present embodiment as has been discussed above, since HoA and CoA are switchingly used in accordance with the quality of the communication network (QoS level), it is possible to perform UDP communication by the use of the care-of address, if necessary, and avoid traffic concentration at the home agent during real-time communication, while maintaining concurrent communication service such as TCP communication at the same time.

Furthermore, in the case of the present embodiment, since the call control device takes the initiative in performing a variety of optimization processes on the basis of QoS control signals as transmitted from the respective mobile terminals (for example, 3a and 3b), it is possible to control communication on the basis of the communication qualities of both the mobile terminals communicating with each other, perform selection of a more appropriate communication route, control the encoding bandwidth, control the intervals between outgoing packets, and adjust traffic load in stages in response to the communication states at both the transmitter and receiver ends.

As a result, in accordance with the present embodiment, it is possible to perform dynamic session control on the basis of QoS by the call control device (SIP server) 1 in a multiple access network environment, for example, by the use of SIP mobility and the 3PCC procedure, such that the communication quality of RT communication is maintained while continuing TCP communication by MIP at the same time.

### Modification Example

Incidentally, the present invention is not limited thereto, but it is possible to add a variety of modification. For example, while the respective optimization processes are performed mainly by the call control device taking the initiative, it is possible to perform optimization mainly by the communicating mobile terminal 3a or 3b which takes the initiative. Namely, the mobile terminal 3a or 3b may detect the communication quality, evaluate the communication quality detected by this mobile terminal, and instruct the call control device 1 and the other correspondent terminal to perform the respective optimization processes (optimization of the communication route, optimization of the encoding bandwidth, optimization of the intervals between outgoing packets) in accordance with the evaluation result. In this case, the call control sections of the respective communication terminal devices perform the optimization processes in response to the instruction from the mobile terminal taking the initiative in the optimization processes in cooperation with the other correspondent terminal and the call control device 1.burden on the processor.

In accordance with this modification example, the communication quality is detected by one of the respective communicating mobile terminals, which evaluates the communication quality, and thereby it is possible to adjust traffic load in stages without increasing the burden on the call control device 1.

### INDUSTRIAL APPLICABILITY

As has been discussed above, in accordance with the present invention, it is possible for a mobile terminal to separate the interface of IP mobility functionality and the interface of real-time communication functionality, dynamically perform session control in accordance with the QoS level of real-time communication, and realize maintenance of the communication quality of the real-time communication while continuing a TCP communication at the same time.

1. A session control system comprising:
mobile terminals operable to perform communication while moving across a communication network; and
a home agent operable to relay communication by the use of a static address fixed independent from the location of the mobile terminal and a care-of address variable depending on the location of the mobile terminal, the static address and care-of address being assigned to each of the mobile terminals, and
the mobile terminal comprising:
an application executing section operable to run an application which performs data transmission and reception;
a communication quality monitoring section operable to detect the communication quality through the communication network; and
an address control section operable to provide the application with either or both of the static address and the care-of address as a receiving address for data transmission and reception in accordance with the type of the application which is run by the application executing section and the detection result by the communication quality monitoring section,
wherein the address control section includes
the functionality of setting a communication route passing through the home agent when the static address is selected as the receiving address, and selecting a communication route which is not passing through the home agent when the care-of address is selected as the receiving address.

2. The session control system as claimed in claim 1 wherein a call control device is installed on the communication network for instructing a call control section provided in each mobile terminal, which is performing the communication, to optimize the communication route in accordance with the communication quality notified from the mobile terminal,
wherein the mobile terminal has the functionality of notifying the call control device of the communication quality detected by the communication quality monitoring section, and
wherein the call control section of the mobile terminal has the functionality of making the address control section select whether or not to use a communication route through the home agent in accordance with the instruction from the call control device.

3. The session control system as claimed in claim 1 wherein a call control device is installed on the communication network for instructing each mobile terminal, which is performing the communication, to optimize the encoding bandwidth of the communication in accordance with the communication quality notified from the mobile terminal,
wherein the mobile terminal has the functionality of notifying the call control device of the communication quality detected by the communication quality monitoring section, and
wherein the mobile terminal has the functionality of performing optimization of the encoding bandwidth in accordance with the instruction from the call control device.

4. The session control system as claimed in claim 1 wherein a call control device is installed on the communication network for instructing each mobile terminal, which is performing the communication, to optimize the intervals between outgoing packets of the communication in accordance with the communication quality notified from the mobile terminal,
wherein the mobile terminal has the functionality of notifying the call control device of the communication quality detected by the communication quality monitoring section, and
wherein the mobile terminal has the functionality of performing optimization of the intervals between outgoing packets in accordance with the instruction from the call control device.

5. (Terminal initiative) The session control system as claimed in claim 1 wherein the mobile terminal is provided with a call control section which instructs a call control device installed on the communication network and the terminal device which is the other end of the communication to optimize the communication route in accordance with the communication quality detected by the communication quality monitoring section, and
wherein the terminal device which is the other end of the communication and the call control device have the functionality of making the address control section select whether or not to use a communication route through the home agent in response to the instruction from the call control section.

6. The session control system as claimed in claim 1 wherein the mobile terminal is provided with a call control section which instructs a call control device installed on the communication network and the terminal device which is the other end of the communication to optimize the encoding bandwidth of the communication in accordance with the communication quality detected by the communication quality monitoring section, and
wherein the terminal device which is the other end of the communication and the call control device have the functionality of performing optimization of the encoding bandwidth in response to the instruction from the call control section.

7. The session control system as claimed in claim 1 wherein the mobile terminal is provided with a call control section which instructs a call control device installed on the communication network and the terminal device which is the other end of the communication to optimize the encoding bandwidth of the communication in accordance with the communication quality detected by the communication quality monitoring section, and
wherein the terminal device which is the other end of the communication and the call control device have the functionality of performing optimization of the intervals between outgoing packets in response to the instruction from the call control section.

8. A session control method comprising:
mobile terminals operable to perform communication while moving across a communication network;
a home agent operable to relay communication by the use of a static address fixed independent from the location of the mobile terminal and a care-of address variable depending on the location of the mobile terminal, the static address and care-of address being assigned to each of the mobile terminals, and
a step (1) of running an application which performs data transmission and reception in the mobile terminal and detecting the communication quality through the communication network in this mobile terminal;
a step (2) of providing the application with either or both of the static address and the care-of address as a receiving address for data transmission and reception in accordance with the type of the application which is run on the mobile terminal and the detection result of the communication quality,
a step (3) of setting a communication route passing through the home agent when the static address is selected as the receiving address and selecting a communication route which is not passing through the home agent when the care-of address is selected as the receiving address, in the step (2).

9. The session control method as claimed in claim 8 wherein, in the step (1), the mobile terminal notifies a call control device installed on the communication network of the communication quality detected by a communication quality monitoring section, and the call control device instructs a call control section provided in the mobile terminal to optimize the communication route in accordance with the communication quality notified from the mobile terminal, and
wherein, in the step (3), the call control section of the mobile terminal selects whether or not to use a communication route through the home agent in accordance with the instruction from the call control device.

10. The session control method as claimed in claim 8 wherein, in the step (1), the mobile terminal notifies a call control device installed on the communication network of the communication quality detected by a communication quality monitoring section, and the call control device instructs each mobile terminal, which is performing the communication, to optimize the encoding bandwidth of the communication in accordance with the communication quality notified from the mobile terminal, and
wherein, in the step (3), the mobile terminal performs optimization of the encoding bandwidth in accordance with the instruction from the call control device.

11. The session control method as claimed in claim 8 wherein, in the step (1), the mobile terminal notifies a call control device installed on the communication network of the communication quality detected by a communication quality monitoring section, and the call control device instructs each mobile terminal, which is performing the communication, to optimize the intervals between outgoing packets in accordance with the communication quality notified from the mobile terminal,
wherein, in the step (3), the mobile terminal performs optimization of the intervals between outgoing packets in accordance with the instruction from the call control device.

12. (Terminal initiative) The session control method as claimed in claim 8 wherein, in the step (1), the mobile terminal instructs a call control device installed on the communication network and the terminal device which is the other end of the communication to optimize the communication route in accordance with the communication quality detected by a communication quality monitoring section, and
wherein, in the step (3), the terminal device which is the other end of the communication and the call control device selects whether or not to use a communication route through the home agent in accordance with the instruction from the mobile terminal.

13. The session control method as claimed in claim 8 wherein, in the step (1), the mobile terminal instructs a call control device installed on the communication network and the terminal device which is the other end of the communication to optimize the encoding bandwidth of the communication in accordance with the communication quality detected by a communication quality monitoring section, and
wherein, in the step (3), the terminal device which is the other end of the communication and the call control device performs optimization of the encoding bandwidth in accordance with the instruction from the mobile terminal.

14. The session control method as claimed in claim 8 wherein, in the step (1), the mobile terminal instructs a call control device installed on the communication network and the terminal device which is the other end of the communication to optimize the encoding bandwidth of the communication in accordance with the communication quality detected by a communication quality monitoring section, and
wherein, in the step (3), the terminal device which is the other end of the communication and the call control device performs optimization of the intervals between outgoing packets in accordance with the instruction from the call control section.

15. A mobile terminal operable in a session control system which comprises:
mobile terminals operable to perform communication while moving across a communication network; and
a home agent operable to relay communication by the use of a static address fixed independent from the location of the mobile terminal and a care-of address variable depending on the location of the mobile terminal, the static address and care-of address being assigned to each of the mobile terminals,
the mobile terminal comprising:
an application executing section operable to run an application which performs data transmission and reception;
a communication quality monitoring section operable to detect the communication quality through the communication network; and
an address control section operable to provide the application with either or both of the static address and the care-of address as a receiving address for data transmission and reception in accordance with the type of the application which is run by the application executing section and the detection result by the communication quality monitoring section,
wherein the address control section includes
the functionality of setting a communication route passing through the home agent when the static address is selected as the receiving address, and selecting a communication route which is not passing through the home agent when the care-of address is selected as the receiving address.

16. The mobile terminal as claimed in claim 15 further comprising the functionality of notifying a call control device installed on the communication network of the communication quality detected by a communication quality monitoring section, and
a call control section operable to make the address control section select whether or not to use a communication route through the home agent in accordance with the instruction acquired of the call control device on the basis of the communication quality notified by the mobile terminal.

17. The mobile terminal as claimed in claim 15 further comprising the functionality of notifying a call control device installed on the communication network of the communication quality detected by a communication quality monitoring section, and
the functionality of performing optimization of the encoding bandwidth in accordance with the instruction acquired of the call control device on the basis of the communication quality notified by the mobile terminal.

18. The mobile terminal as claimed in claim 15 further comprising the functionality of notifying a call control device installed on the communication network of the communication quality detected by a communication quality monitoring section, and
the functionality of performing optimization of the intervals between outgoing packets in accordance with the instruction acquired of the call control device on the basis of the communication quality notified by the mobile terminal.

19. (Terminal initiative) The mobile terminal as claimed in claim 15 further comprising a call control section which instructs a call control device installed on the communication network and the terminal device which is the other end of the communication to optimize the communication route in accordance with the communication quality detected by the communication quality monitoring section,
wherein the address control section has the functionality of selecting whether or not to use a communication route through the home agent in cooperation with the terminal device which is the other end of the communication and the call control device.

20. The mobile terminal as claimed in claim 15 further comprising a call control section which instructs a call control device installed on the communication network and the terminal device which is the other end of the communication to optimize the encoding bandwidth of the communication in accordance with the communication quality detected by the communication quality monitoring section,
wherein the address control section has the functionality of optimizing the encoding bandwidth in cooperation with the terminal device which is the other end of the communication and the call control device.

21. The mobile terminal as claimed in claim 15 further comprising a call control section which instructs a call control device installed on the communication network and the terminal device which is the other end of the communication to optimize the encoding bandwidth of the communication in accordance with the communication quality detected by the communication quality monitoring section,
wherein the address control section has the functionality of optimizing the intervals between outgoing packets in cooperation with the terminal device which is the other end of the communication and the call control device.
